(19) United States
(12) Patent Application Publication
(10) Pub. No.: US 2006/0227278 A1
(43) Pub. Date: Oct. 12, 2006

(54) Liquid crystal display panel

(75) Inventor: Chih-Yen Chiang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/401,083

(22) Filed: Apr. 10, 2006

(30) Foreign Application Priority Data
Apr. 9, 2005 (CN) 200510034115.3

(51) Int. Cl. G02F 1/1345

(52) U.S. Cl. 349/149

(57) ABSTRACT

An LCD panel (110) includes a substrate (112), a gate driver IC (117), a source driver IC (118) and a flexible circuit board (119). The substrate includes a display area (114) and a circuit area (116) abutting an outer side of the display area. The flexible circuit board includes a plurality of conducting wires (1193, 1194) extending to connect to the gate driver IC and the source driver IC. The gate driver IC and the source driver IC are on a central part of the circuit area. One of the gate driver IC and the source driver IC is positioned distal from the display area, and the other of the gate driver IC and the source driver IC is positioned generally between the display area and said one of the gate driver IC and the source driver IC. The flexible circuit board is connected to an outer portion of the circuit area.

### FIELD OF THE INVENTION

The present invention relates to liquid crystal display (LCD) panels.

### GENERAL BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 3 is a schematic, top plan view of a conventional LCD panel, showing hidden portions thereof in phantom. The LCD panel 10 includes a glass substrate 12 having a display area 14 and a circuit area 16 surrounding the display area 14 on a surface of the substrate 12, a source driver IC 18 and a gate driver IC (integrated circuit) 20 positioned on the circuit area 16, and a flexible printed circuit board 22 connected to an edge of the circuit area 16.

The flexible printed circuit board 22 includes a circuit, which includes a plurality of conducting wires 24, 25. The conducting wires 24, 25 are electrically connected to the source driver IC 18, the gate driver IC 20, and electrodes (not shown) on the glass substrate 12, for connecting the LCD panel 10 to an external electronic devices (not shown), and for transmitting signals to the source driver IC 18 and the gate driver IC 20. The source driver IC 18 and the gate driver IC 20 control displaying of images on the LCD panel 10 by inputting signals to the electrodes (not shown) on the glass substrate 12. In addition, the flexible circuit board 112 can be a flexible printed circuit (FPC) board, a flexible copper clad laminate (FCCL), or a tape carrier package (TCP).

The source driver IC 18 and the gate driver IC 20 are positioned on different sides of the circuit area 16 for respectively controlling data lines (not shown) and scanning lines (not shown) of the LCD panel 10. This makes the conducting lines (not labeled) extending from the source driver IC 18 and the gate driver IC 20 to the display area 14 of the LCD panel 10 asymmetrical. Then, crosstalk can be appeared on the LCD panel 10 because the asymmetrcal distribution of the conducting wires extending from the source driver IC 18 and the gate driver IC 20 to the display area 14.

It is desired to provide an LCD panel which overcomes the above-described deficiencies.

### SUMMARY

An LCD panel includes a substrate, a gate driver IC, a source driver IC, and a flexible circuit board. The substrate includes a display area and a circuit area abutting an outer side of the display area. The flexible circuit board includes a plurality of conducting wires extending to connect to the gate driver IC and the source driver IC. The gate driver IC and the source driver IC are on a central part of the circuit area. One of the gate driver IC and the source driver IC is positioned distal from the display area, and the other of the gate driver IC and the source driver IC is positioned generally between the display area and said one of the gate driver IC and the source driver IC. The flexible circuit board is connected to an outer portion of the circuit area.

Advantages and novel features of the above-described LCD panels will become more apparent from the following detailed description when taken in conjunction with the accompanying drawings, in which:

### BRIEF DESCRIPTION OF THE DRAWINGS

FIG. 1 is a schematic, top plan view of an LCD panel according to a first embodiment of the present invention, showing hidden portions thereof in phantom.

FIG. 2 is a schematic, top plan view of an LCD panel according to a second embodiment of the present invention, showing hidden portions thereof in phantom.

FIG. 3 is a schematic, top plan view of a conventional LCD panel, showing hidden portions thereof in phantom.

### DETAILED DESCRIPTION OF PREFERRED EMBODIMENTS

Reference will now be made to the drawings to describe the present invention in detail.

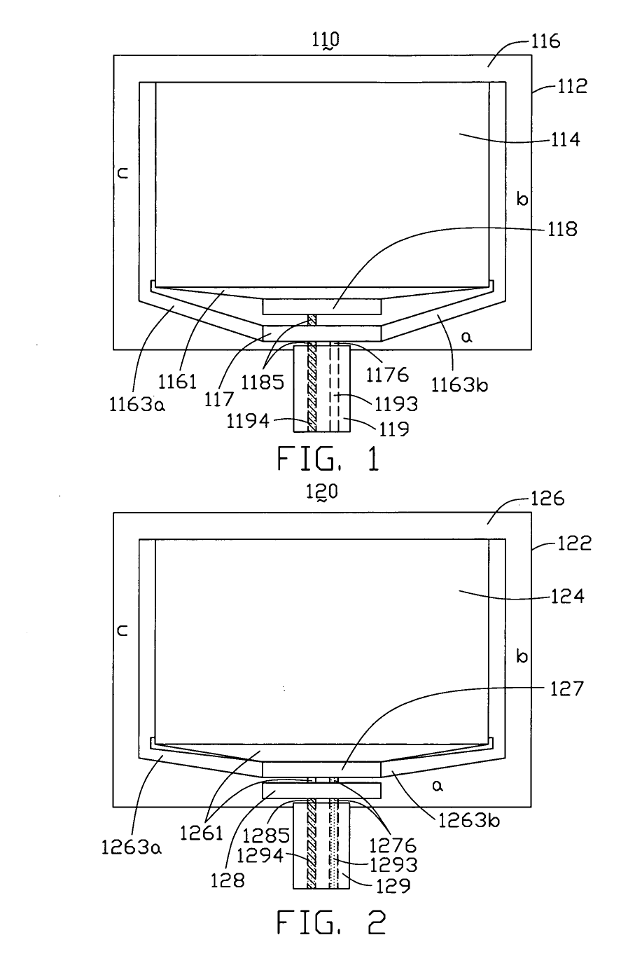

FIG. 1 is a schematic, top plan view of an LCD panel 110 according to a first embodiment of the present invention, showing hidden portions thereof in phantom. The LCD panel 110 includes a glass substrate 112, a plurality of first conducting wires 1161, a plurality of second conducting wires 1163a, 1163b, a gate driver IC 117, a source driver IC 118, and a flexible circuit board 119.

The glass substrate 112 includes a central display area 114, and a circuit area 116 abutting an outer side of the display area 114. The circuit area 116 includes a first margin area “a”, a second margin area “b”, and a third margin area “c”. Two opposite ends of the first margin area “a” connect to the second margin area “b” and the third margin area “c” respectively. The first margin area “a”, the second margin area “b” and the third margin area “c” abut three of four sides of the display area 114.

The gate driver IC 117 and the source driver IC 118 are positioned on a central part of the first margin area “a” of the circuit area 116. The gate driver IC 117 and the source driver IC 118 are oriented parallel to the outer side of the display area 114. The source driver IC 118 is positioned between the gate drive IC 117 and the display area 114. The gate driver IC 117 and the source driver IC 118 can be installed on the glass substrate 112 by chip on glass (COG) technology.

The first conducting wires 1161 are positioned on the first margin area “a” of the circuit area 116, and extend from the display area 114 to connect to the source driver IC 118. The first conducting wires 1161 are arranged in the form of bilateral symmetry.

The second conducting wires 1163a, 1163b extend from two opposite sides of the display area 114 respectively, to respectively connect to two opposite sides of the gate driver IC 117. The second conducting wires 1163a are positioned on the third margin area “c” and an adjoining part of the first margin area “a”. The overall configuration of the second conducting wires 1163a is similar to an “L” shape. The second conducting wires 1163b are positioned on the second margin area “b” and an adjoining part of the first margin area “a”. The overall configuration of the second conducting wires 1163b is similar to a reversed “L” shape. The internal configuration of each of the second conducting wires 1163a, 1163b is arranged in the form of bilateral symmetry.

The flexible circuit board 119 is connected to a central outmost perimeter part of the first margin area “a” of the circuit area 116, abuts the gate driver IC 117. The flexible circuit board 119 includes a plurality of third conducting wires 1193 and a plurality of fourth conducting wires 1194. The fourth conducting wires 1194 are connected to the source driver IC 118 via a plurality of fifth conducting wires 1185. The fifth conducting wires 1185 are positioned on the first margin area “a” at an outer side of the source IC 118, including below a main body of the gate driver IC 117. The third conducting wires 1193 are connected to the gate driver IC 117 via a plurality of sixth conducting wires 1176, which are positioned on the first margin area “a”. In addition, the flexible circuit board 119 can be a flexible printed circuit (FPC) board, a flexible copper clad laminate (FCCL), or a tape carrier package (TCP).

The flexible circuit board 119 serves as a connector for connecting the LCD panel 110 to an external electronic device (not shown). The third conducting wires 1193 of the flexible circuit board 119 are used to transmit scanning signals directly to the gate driver IC 117. The fourth conducting wires 1194 are use to transmit image signals directly to the source driver IC 118. The gate driver IC 117 provides the received scanning signals to electrodes (not shown) on the glass substrate 112 via the second conducting wires 1163a, 1163b. The source driver IC 118 provides the received image signals to electrodes (not shown) on the glass substrate 112 via the first conducting wires 1161. The source driver IC 118 and the gate driver IC 117 control displaying of images on the LCD panel 110, by inputting scanning signals and image signals to the electrodes (not shown) on the glass substrate 112.

Because the source driver IC 118 and the gate driver IC 117 are disposed in that order at the central part of the first margin area “a” at the same side of the circuit area 116, the conducting wires 1161, 1163a, 1163b can be arranged to have a bilateral symmetry distribution. This avoids crosstalk that may otherwise be caused by the asymmetrcal distribution of the first and second conducting wires 1161, 1163a, 1163b. Furthermore, because the second conducting wires 1163a, 1163b extend from two opposite sides of the display area 114 to respectively connect to two opposite sides of the gate driver IC 117, this leaves a large amount of space on the first margin area “a” at an outside of the gate driver IC 117 for positioning the fifth conducting wires 1185 and the sixth conducting wires 1176.

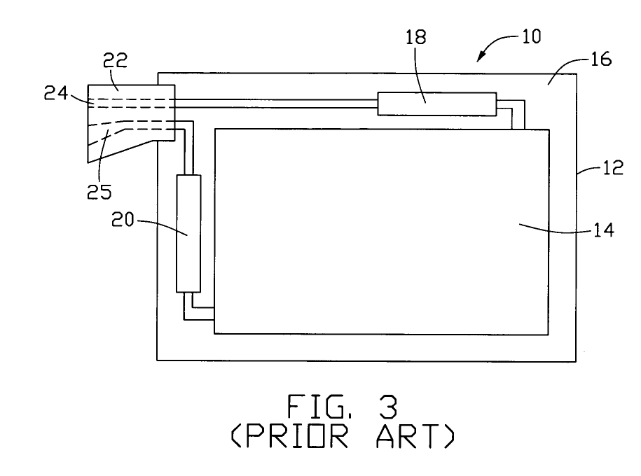

FIG. 2 is a schematic, top plan view of an LCD 120 panel according to a second embodiment of the present invention, showing hidden portions thereof in phantom. The LCD panel 120 includes a central glass substrate 122, a plurality of first conducting wires 1261, a plurality of second conducting wires 1263a, 1263b, a gate driver IC 127, a source driver IC 128, and a flexible circuit board 129.

The circuit area 126 includes a first margin area “a”, a second margin area “b”, and a third margin area “c”. Two opposite ends of the first margin area “a” connect to the second margin area “b” and the third margin area “c” respectively. The first margin area “a”, the second margin area “b” and the third margin area “c” abut three of four sides of the display area 124.

The gate driver IC 127 and the source driver IC 128 are orderly positioned on a central part of the first margin area “a” of the circuit area 126. The gate driver IC 127 and the source driver IC 128 are oriented parallel to the outer side of the display area 124. The gate driver IC 127 is positioned between the source drive IC 128 and the display area 124.

The first conducting wires 1261 extend from the display area 124 to directly connect to the source driver IC 128. The first conducting wires 1261 are positioned on the first margin area “a” of the circuit area 126, including below a main body of the gate driver IC 127. The first conducting wires 1261 are arranged in the form of bilateral symmetry.

The conducting wires 1263a, 263b extend from two opposite sides of the display area 124 respectively, to respectively connect to two opposite sides of the gate driver IC 127. The second conducting wires 1263a are positioned on the third margin area “c” and an adjoining part of the first margin area “a”. The overall configuration of the second conducting wires 1263a is similar to an “L” shape. The second conducting wires 1263b are positioned on the second margin area “b” and an adjoining part of the first margin area “a”. The overall configuration of the second conducting wires 1263b is similar to a reversed “L” shape. The internal configuration of each of the second conducting wires 1163a, 1163b is arranged in the form of bilateral symmetry.

The flexible circuit board 129 is connected to a central outmost perimeter part of the first margin area “a” of the circuit area 126, abuts the source driver IC 128. The flexible circuit board 129 includes a plurality of third conducting wires 1293 and a plurality of fourth conducting wires 1294. The fourth conducting wires 1294 are connected to the source driver IC 128 via a plurality of fifth conducting wires 1285. The third conducting wires 1293 are connected to the gate driver IC 127 via a plurality of sixth conducting wires 1276. The sixth conducting wires are positioned on the first margin area “a” at an outer side of the gate IC 127, including below a main body of the source driver IC 128, including below a main body of the source driver IC 128.

The flexible circuit board 129 serves as a connector for connecting the LCD panel 120 to an external electronic devices (not shown). The third conducting wires 1293 of the flexible circuit board 129 are used to transmit scanning signals directly to the gate driver IC 127. The fourth conducting wires 1294 are use to transmit image signals directly to the source driver IC 128. The gate driver IC 127 provides the received scanning signals to the electrodes (not shown) on the glass substrate 122 via the second conducting wires 1263a, 1263b. The source driver IC 128 provides the received image signals to the electrodes (not shown) on the glass substrate 122 via the first conducting wires 1261. The source driver IC 128 and the gate driver IC 127 control displaying of images on the LCD panel 120, by inputting scanning signals and image signals to the electrodes (not shown) on the glass substrate 122.

Because the second conducting wires 1263a, 1263b extend from two opposite sides of the display area 124 to respectively connect to two opposite sides of the gate driver IC 127, this leaves a large mount of space on the first margin area “a” at a outside of the gate driver IC 127 for positioning the first conducting wires 1161.

The present invention can be applied to various LCD panels, such as amorphous silicon thin film transistor LCD panels. In addition, the present invention can be applied to any information products that require a symmetrical display, such as a smart phone or a cellular phone. Besides, the shape of the glass substrate and the flexible circuit board is not limited to rectangle, and can also be a regular octagon or an isosceles trapezoid.

Those skilled in the art will readily appreciate that numerous modifications and alterations of the above-described devices may be made without departing from the scope of the principles of the present invention. Accordingly, the above disclosure should be construed as limited only by the metes and bounds of the appended claims or equivalents thereof.

What is claimed is:

1. A liquid crystal display panel comprising:
a substrate comprising a display area, and a circuit area abutting an outer side of the display area;
a gate driver IC (integrated circuit) and a source driver IC on a central part of the circuit area, one of the gate driver IC and the source driver IC being positioned distal from the display area, and the other of the gate driver IC and the source driver IC being positioned generally between the display area and said one of the gate driver IC and the source driver IC; and
a flexible circuit board connected to an outer portion of the circuit area, the flexible circuit board comprising a plurality of conducting wires extending to connect to the gate driver IC and the source driver IC.

2. The liquid crystal display panel as claimed in claim 1, wherein the gate driver IC and the source driver IC are oriented parallel to the outer side of the display area.

3. The liquid crystal display panel as claimed in claim 2, wherein the source driver IC is positioned between the gate driver IC and the display area.

4. The liquid crystal display panel as claimed in claim 3, further comprising a plurality of first conducting wires and a plurality of second conducting wires, the first conducting wires extending from the display area to connect to the source driver IC, the second conducting wires extending from the display area to connect to the gate driver IC.

5. The liquid crystal display panel as claimed in claim 4, wherein the second conducting wires extend from two opposite sides of the display area to respectively connect to two opposite sides of the gate driver IC.

6. The liquid crystal display panel as claimed in claim 5, wherein the first conducting wires are arranged in the form of bilateral symmetry, and the second conducting wires are arranged in the form of bilateral symmetry.

7. The liquid crystal display panel as claimed in claim 1, wherein the flexible circuit board comprises a plurality of third conducting wires for connecting and transmitting scanning signals to the gate driver IC, and a plurality of fourth conducting wires for connecting and transmitting image signals to the source driver IC.

8. The liquid crystal display panel as claimed in claim 7, further comprising a plurality of fifth conducting wires for connecting the fourth conducting wires and the source driver IC, wherein the fifth conducting wires are positioned at an outer side of the source IC, comprising below a main body of the gate driver IC.

9. The liquid crystal display panel as claimed in claim 2, wherein the gate driver IC is positioned between the source driver IC and the display area.

10. The liquid crystal display panel as claimed in claim 9, further comprising a plurality of first conducting wires and a plurality of second conducting wires, the first conducting wires extending from the display area directly to connect to the source driver IC, the second conducting wires extending from the display area to connect to the gate driver IC, the first conducting wires are positioned on the first margin area “a” of the circuit area, comprising below a main body of the gate driver IC.

11. The liquid crystal display panel as claimed in claim 10, wherein the second conducting wires extend from two opposite sides of the display area to respectively connect to two opposite sides of the gate driver IC.

12. The liquid crystal display panel as claimed in claim 11, wherein the first conducting wires are arranged in the form of bilateral symmetry, and the second conducting wires are arranged in the form of bilateral symmetry.

13. The liquid crystal display panel as claimed in claim 12, wherein the flexible circuit board comprises a plurality of third conducting wires for connecting and transmitting scanning signals to the gate driver IC, and a plurality of fourth conducting wires for connecting and transmitting image signals to the source driver IC.

14. The liquid crystal display panel as claimed in claim 13, further comprising a plurality of fifth conducting wires for connecting the fourth conducting wires and the source driver IC, and a plurality of sixth conducting wires for connecting the third conducting wires and the gate driver IC, wherein the sixth conducting wires are positioned at an outer side of the gate IC on the first margin area “a” of the circuit area, comprising below a main body of the source driver IC.

15. The liquid crystal display panel as claimed in claim 1, wherein the substrate is a rectangular substrate.

16. The liquid crystal display panel as claimed in claim 1, wherein the liquid crystal display panel is configured to be in a cellular phone or a smart phone.

17. The liquid crystal display panel as claimed in claim 1, wherein the flexible circuit board is a flexible printed circuit (FPC) board, a flexible copper clad laminate (FCCL), or a tape carrier package (TCP).

18. A liquid crystal display panel comprising:
a substrate comprising a display area, and a circuit area located on an outer side of the display area;
a gate driver IC (integrated circuit) and a source driver IC located on the circuit area, one of the gate driver IC and the source driver IC being positioned relatively far from the display area than the other, and said other of the gate driver IC and the source driver IC being positioned generally between the display area and said one of the gate driver IC and the source driver IC in a direction; and
a flexible circuit board connected to an outer portion of the circuit area, the flexible circuit board comprising a plurality of conducting wires extending to connect to the gate driver IC and the source driver IC.

19. The liquid crystal display panel as claimed in claim 18, wherein said get driver IC and said source driver IC are aligned with each other along said direction.

20. A liquid crystal display panel comprising:
a substrate comprising a display area, and a circuit area located on an outer side of the display area;
a gate driver IC (integrated circuit) and a source driver IC located on the circuit area, both the gate driver IC and the source driver IC being located on a same side of said display area,; and
a flexible circuit board connected to an outer portion of the circuit area, the flexible circuit board comprising a plurality of conducting wires extending to connect to the gate driver IC and the source driver IC on said same side.
